(19) United States
(12) Patent Application Publication
(10) Pub. No.: US 2014/0341148 A1
(43) Pub. Date: Nov. 20, 2014

(54) BEARER CONFIGURATION FOR BACKGROUND TRAFFIC

(71) Applicant: Nokia Corporation, Espoo (FI)

(72) Inventors: lkka Antero Keskitalo, Oulu (FI); Jussi-Pekka Koskinen, Oulu (FI); Hannu Eero Oskari Bergius, Kangasala (FI)

(73) Assignee: Nokia Corporation, White Plains, NY (US)

(21) Appl. No.: 14/368,267

(22) PCT Filed: Dec. 30, 2011
(86) PCT No.: PCT/US11/68122

§ 371 Date: Jun. 23, 2014

(51) Int. Cl. H04W 72/04

(52) U.S. Cl. CPC H04W 72/0453
USPC 370/329

(57) ABSTRACT

Methods and apparatus, including computer program products, are provided for configuring bearers for background traffic. In some exemplary embodiments, there is provided a method. The method may include processing parameters defining at least a first bearer and a second bearer, the first bearer and the second bearer established for a service at a processor; sending, based on at least the first bearer, traffic generated by the service, when at least one of the service and the processor is not in a background mode; and sending, based on at least the second bearer, background traffic generated by the service, when at least one of the service and the processor is in the background mode. Related apparatus, systems, methods, and articles are also described.

### FIELD

The subject matter described herein relates to wireless communications.

### BACKGROUND

Mobile phones have evolved from devices limited to placing voice calls to the multi-faceted smart phones available today. Indeed, smart phones allow a user to download a variety of applications based on the given needs and desires of the user. These applications not only provide traditional services, such as email and text messaging, but also provide other services, such as location-based services, social networking, video streaming, music players, games, weather, and the like. As such, many users rely on their smart phone for a variety of services each and every day.

### SUMMARY

Methods and apparatus, including computer program products, are provided for configuring bearers for background traffic.

In some exemplary embodiments, there is provided a method. The method may include processing parameters defining at least a first bearer and a second bearer, the first bearer and the second bearer established for a service at a processor; sending, based on at least the first bearer, traffic generated by the service, when at least one of the service and the processor is not in a background mode; and sending, based on at least the second bearer, background traffic generated by the service, when at least one of the service and the processor is in the background mode.

In some exemplary embodiments, the above-noted aspects may further include additional features described herein including one or more of the following. The first bearer may include at least an access stratum bearer and a non-access stratum bearer including access stratum configuration information for the traffic and non-access stratum configuration information for the traffic. The second bearer may include at least an access stratum bearer and a non-access stratum bearer including access stratum configuration information for the background traffic and non-access stratum configuration information for the background traffic, wherein the second bearer is configured for the background traffic. The first bearer and the second bearer may be the same bearer, wherein the second bearer includes different configuration information, when compared to the first bearer. The different configuration information may include quality of service parameters. The background mode may include a mode in which at least one of the service and the processor are inactive for a first period of time. The traffic may include data sent by the service, when a user accesses and interacts with at least one of the service and the processor. The background mode may be entered, when at least one of the service and the processor is inactive for the first period of time. An active mode may be entered, when at least one of the service and the processor is not in the background mode, wherein the active mode is representative of at least one of the service and the processor being used by a user. The background traffic may include data sent by the service, when a user of the service does not at least one of access and interact with the service. The background traffic may include at least one of a status message, a keep-alive message, and an update message sent to another application responsive to the application.

In some exemplary embodiments, there may also be provided a method. The method may include establishing at least a first bearer and a second bearer; sending, based on at least the first bearer, traffic to a user equipment, when at least one of a service and the user equipment is not in a background mode; and sending, based on at least the second bearer, background traffic to the user equipment, when at least one of the service and the user equipment is in the background mode.

In some exemplary embodiments, the above-noted aspects may further include additional features described herein including one or more of the following. The first bearer may include at least an access stratum bearer and a non-access stratum bearer including access stratum configuration information for the traffic and non-access stratum configuration information for the traffic. The second bearer may include at least an access stratum bearer and a non-access stratum bearer including access stratum configuration information for the background traffic and non-access stratum configuration information for the background traffic, wherein the second bearer is configured for the background traffic. The first bearer and second bearer may be different bearers. The first bearer and second bearer may be the same bearer, wherein the second bearer includes different configuration information, when compared to the first bearer. The different configuration information may include quality of service parameters. An indication of whether the user equipment is in the background mode may be received from the user equipment. A determination of whether the user equipment is in the background mode may be made from the traffic received from the user equipment.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example, of a wireless communication system, in accordance with some exemplary embodiments;

FIG. 2 depicts an example of a process for configuring bearers for a background mode of an application operating at a user equipment, in accordance with some exemplary embodiments;

FIG. 3 depicts another example of a process for configuring bearers for a background mode of an application operating at a user equipment, in accordance with some exemplary embodiments;

FIG. 4 depicts an example of a base station, in accordance with some exemplary embodiments; and

FIG. 5 depicts an example of a user equipment, in accordance with some exemplary embodiments;

Like labels are used to refer to same or similar items in the drawings.

### DETAILED DESCRIPTION

Today's phones increasingly include applications that require continuous, nearly continuous, and/or regular access to the network in order to provide a service. These so-called “always-on” applications may raise issues not previously experienced in user equipment, such as smart phones and the like. Generally, the user equipment may be controlled to optimize network performance and at the same time optimize the user's experience while operating the user equipment. This user experience may include considerations, such as service availability in different parts of the network, service quality in terms of providing sufficient data rates and/or minimizing latencies, power consumption optimization at the user equipment when there is no active data transfer between the user equipment and the network, and power consumption optimization at the user equipment when background traffic from always-on applications are operating at the user equipment. Indeed, these always-on applications may transmit status updates, keep-alive messages, and other data to a server on the network even when the user has stopped using the always-on application, the user equipment, or both. In any case, the network (or nodes therein) may control the idle and connected states of the user equipment and control the discontinuous receive (DRX) configurations in order to satisfy these user experience needs while optimizing network performance.

For example, a user equipment may include one or more always-on applications, an example of which is a social networking application sending status updates, location updates, keep-alive messages, and the like to a corresponding social networking server even when the user is not actively using the social networking application and/or the user equipment hosting the social networking application. In this example, the social networking application may be always-on in the sense that the social networking application continuously, nearly continuously, and/or regularly sends background traffic to another application, such as a social networking application at a server or website, even when the user equipment, social networking application, or both are not being used or accessed by the user. This background traffic may provide the social networking server with status updates, keep-alive packets, location updates, polling, and the like. Although the previous example refers to a social networking application as the always-on application, other types of always-on applications may be used as well at the user equipment.

In some exemplary embodiments, the subject matter disclosed herein may provide apparatus, methods, and articles of manufacture to configure a network and/or user equipment to operate with the background traffic associated the user equipment's always-on applications, which may be connected continuously, nearly continuously, and/or intermittently with a server in the network, even when a user is not actively using the user equipment. For example, in some exemplary embodiments, bearers, such as an access stratum bearer and a non-access stratum bearer, including configuration information may be used for normal traffic (also referred to herein as active traffic and non-background traffic), and different bearers including configuration information may be used for background traffic. Although in some exemplary embodiments, the same bearers are used for both active traffic and background traffic, but the allocated access stratum and non-access stratum parameters or configurations may be different, or modified, based on whether active or background traffic is being communicated (e.g., sent, received, or both).

In some exemplary embodiments, the subject matter disclosed herein may control the quality of service (QoS), the DRX, and/o the radio resource control (RRC) states based on whether the traffic being generated by the application at the user equipment corresponds to active traffic generated by the application, when the user is operating the application or corresponds to background traffic generated by the application to a server, when the user is not actively using the application and/or user equipment.

In some exemplary embodiments, when bearers, such as access stratum (AS) bearers and/or non-access stratum (NAS) bearers, are established, the network may take into account whether the bearers will carry active traffic or background traffic. For example, an access stratum bearer and a non-access stratum bearer including configuration information may be established for active traffic, and different access stratum and non-access stratum bearers including configuration information may be used for background traffic, so that active traffic (e.g., data) is communicated between the user equipment and the network in accordance with the bearers established for active traffic, and background traffic is communicated between the user equipment and the network in accordance with the different bearers established for background traffic.

Although in some exemplary embodiments, when the traffic changes between active traffic and background traffic, the network may continue to use the same default access stratum bearer and non-access stratum bearer but these bearers may be different to take into account the change. For example, the first bearer and second bearer may be the same bearer, but the second bearer may include for example different, when compared to the first bearer, quality of service parameters, packet data convergence protocol (PDCP), radio link control (RLC) information, logical channel configuration information, and NAS configuration information. Furthermore, the physical layer and the media access control (MAC) configurations and non-access stratum parameters (as well as for example the information at Table 1, lines 7-24, 41-51, and 55-58 and at Table 2, lines 5, 9, and 11-12) may be different for background and normal data (e.g., the parameters/configuration of the bearers may be modified to represent a lower quality of service when background traffic is being sent by the application).

As noted, separate bearer configurations may, in some exemplary embodiments, be used for background traffic and active traffic. The active traffic may be configured to take into account that the active traffic is more sensitive to the user experience factors from a quality of service perspective, when compared to background traffic. As such, the usage of the two sets of bearers (or parameters therein) allows the network and/or user equipment to be configured on-the-fly to react to changes between active traffic and background traffic being carried in accordance with the access stratum bearers and the non-access stratum bearers. For example, a separate access stratum bearer, such as a Data Radio Bearer (DRB), may be used for normal or active traffic, and this access stratum bearer may be mapped to a corresponding non-access stratum bearer to carry the active traffic generated from the application to the network. When the background mode state occurs at the application and/or the user equipment, background traffic may be carried in accordance with different background mode bearers configured for background traffic.

Although in some exemplary embodiments, when a background mode state change occurs, the network and/or user equipment may continue to use the same default bearer used in active mode, but the default bearer may be configured, when established, to handle either active or background traffic.

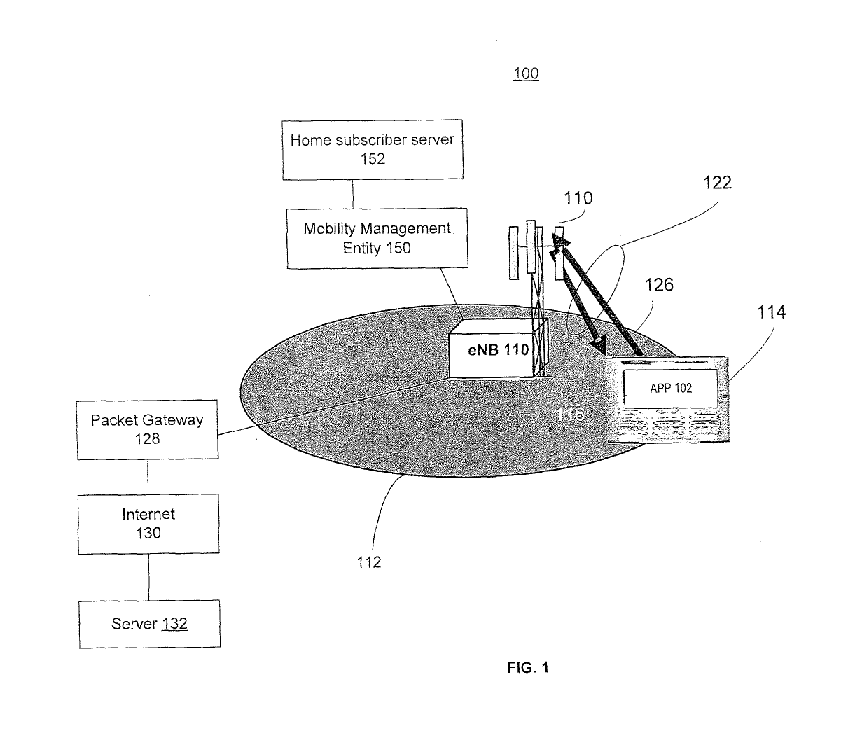

Before providing additional examples and description, an example system 100 framework is described at FIG. 1. FIG. 1 is a simplified functional block diagram of a wireless communication system 100. The wireless communication system 100 includes a base station 110 (labeled eNB) supporting a corresponding service or coverage area 112 (also referred to as a cell). The base station 110 is capable of communicating with wireless devices, such as user equipment 114, within its coverage area. User equipment 114 may include one or more applications, such as application 102 configured as an always-on type of application, as disclosed herein. Application 102 has a corresponding server 132, with which it is connected at the application layer. For example, if application 102 were implemented as a social networking application, then server 102 would correspond to a social networking server or website responsive to application 102. Although FIG. 1 depicts a single base station 110, a single cell 112, and a single user equipment 114, the wireless communication system 100 may include other quantities of base stations, cells, user equipment, and other devices as well.

The base station 110, in some exemplary embodiments, may be implemented consistent with one or more standards referred to generally as GERAN (GSM/EDGE Radio Access Network), UTRAN (UMTS Radio Access Network), E-UTRAN (Evolved UTRAN, which is also referred to as Long Term Evolution (LTE)), and/or LTE-A (Long Term Evolution-Advanced), as well as any subsequent additions or revisions to those standards. For example, the base station 110 may be implemented as an evolved Node B (eNB) type base station consistent with standards, such as 3GPP TS 36.201, “Evolved Universal Terrestrial Radio Access (E-UTRA); Long Term Evolution (LTE) physical layer; General description,” 3GPP TS 36.211, “Evolved Universal Terrestrial Radio Access (E-UTRA); Physical channels and modulation,” 3GPP TS 36.212, “Evolved Universal Terrestrial Radio Access (E-UTRA); Multiplexing and channel coding,” 3GPP TS 36.213, “Evolved Universal Terrestrial Radio Access (E-UTRA); Physical layer procedures,” 3GPP TS 36.214, “Evolved Universal Terrestrial Radio Access (E-UTRA); Physical layer—Measurements,” and any subsequent additions or revisions to these and other 3GPP standards. Although the aforementioned standards are described, the base station 110 may be implemented using other technologies and standards as well.

Although FIG. 1 depicts an example of a configuration for base station 110, the base station 110 may be configured in other ways as well and include, for example, relays, cellular base station transceiver subsystems, gateways, access points, radio frequency (RF) repeaters, frame repeaters, and include access to other networks. For example, base station 110 may have wired and/or wireless backhaul links to other network elements, such as other base stations, a mobility management entity 150, a home subscriber server 152, a packet gateway 128, the Internet 130, a server 132 (e.g., a server connected, at the application layer, to application 102), and/or any other type of network node.

The wireless communication system 100 may include, in some exemplary embodiments, access links, such as links 122. The access links 122 include a downlink 116 for transmitting to the user equipment 114 and an uplink 126 for transmitting from user equipment 114 to the base station 110. The downlink 116 and uplink 126 each represent a radio frequency (RF) signal. The RF signal may carry data, such as voice, video, images, application data (also referred to as traffic), Internet Protocol (IP) packets, control information (e.g., radio resource control messages and the like), and any other type of information.

The user equipment 114 may, in some exemplary embodiments, be implemented as a mobile device and/or a stationary device. The user equipment 114 may be referred to as, for example, a mobile station, a mobile unit, a subscriber station, a wireless terminal, a smart phone, a wireless tablet, and the like. The user equipment 114 may, in some exemplary embodiments, be implemented as, for example, a wireless handheld device, a wireless plug-in accessory, and the like. In some exemplary embodiments, the user equipment 114 may include a processor, a computer-readable storage medium (e.g., memory, storage, and the like), a radio access mechanism, and a user interface.

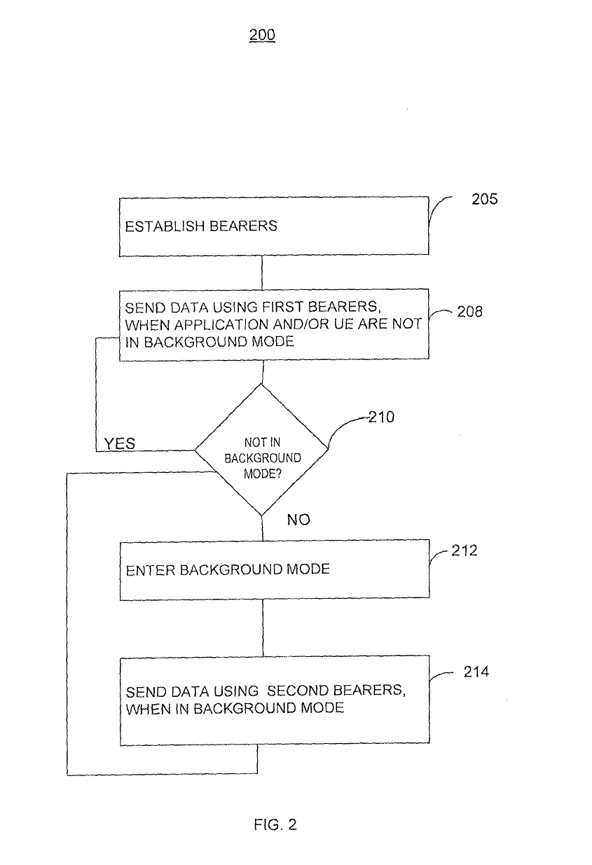

FIG. 2 depicts an example of a process 200 for providing bearers configured for background traffic, in accordance with some exemplary embodiments. The description of process 200 also refers to FIG. 1.

Bearers may, in some exemplary embodiments, be established at 205. In some exemplary embodiments, bearers may be established specifically for the traffic transmitted and/or received when the application 102 and/or the user equipment 114 are not in a background mode (also referred to herein as an active mode, a normal mode, and non-background mode). In addition, bearers may be established specifically for the traffic transmitted and/or received when the application 102 and/or the user equipment 114 are in a background mode. For example, the network may establish one or more bearers for the active mode traffic generated by application 102 at user equipment 114, and the network may establish one or more other bearers for the background mode traffic generated by application 102 at user equipment 114, when the user of the user equipment is not actively using the user equipment 114 and/or application 102. The bearers may include one or more access stratum (AS) bearers and one or more non-access stratum (NAS) bearers. Information regarding the established bearers may be communicated between the network, such as eNB-type base station, and user equipment 114 using messages, such as radio resource control messages, context request messages, activate default bearer context request messages, and the like.

In some exemplary embodiments, the user equipment 114 may include one or more applications, and the network may include one or more applications (also referred to as services) as well. Moreover, the application/service at the network may be configured to contact the user equipment autonomously (e.g., as a push-type service) without the user actively contacting the service.

In some exemplary embodiments, the same bearers may be established at 205 for both active and background traffic modes, such that when in a background mode, the bearers are provided with different parameters and/or configurations to take into account the different quality of service needs of the background mode traffic.

In some exemplary embodiments, data may be sent, at 208, using bearers, established at 205. For example, for the active mode traffic, when the user of the user equipment 114 is actively using the user equipment 114 and/or application 102, active mode bearers established at 205 may include parameters defining the quality of service (QoS) allocated to the active mode traffic (also referred to as normal traffic, traffic, and non-background traffic). These parameters may specify a QoS class indicator (QCI, which define how traffic for that bearer should be handled in the transmission chain), a minimum and/or a maximum bit rate for the uplink 126 and downlink 116, a guaranteed bit rate for the uplink 126 and downlink 116, and/or other parameters affecting quality of service. The application 102 may send any active mode traffic (e.g., data) to the server 132 via network, such as eNB-type base station 110 and/or packet gateway 128, in accordance with the active mode bearers established at 205 and the allocated quality of service parameters for the established active mode bearers.

Although 208 refers to sending data, the application 102 may also receive any active mode traffic sent from eNB-type base station 110, in accordance with the active mode bearers established at 205 and the allocated quality of service parameters for the established active mode bearers. In embodiments in which the same bearers are used for both active and background mode, the traffic may be communicated using default bearers established at 205.

In some exemplary embodiments, the application 102 may be monitored, at 210, to determine whether the application 102, the user equipment, or both are actively being used by the user of user equipment 114. For example, the user equipment 114 may determine that the user has not used the user equipment 114 for a certain period of time and/or that the user has not used the application 102 for a certain period of time. When the application 102, user equipment 114, or both are inactive, the application 102 at user equipment 114 may enter a background mode (NO at 210, and 212). For example, if the user equipment 114, application 102, or both are not used for a given period of time, the display screen of the user equipment 114 may go dark or go to a screen saver mode, which may indicate that the user equipment 114 is not actively being used. Moreover, if the user is not accessing the application 102 by, for example, entering, viewing, or processing data at a user interface for the application 102, this may represent that application 102 is not actively being used. In any case, the application 102 may enter a background mode (NO at 210, and 212).

Although the user equipment 114 and/or application 102 may monitor whether they are in active mode or background mode, the network, such as the server 132, eNB-type base station 110, and/or other network node, may also determine that the user has not used the user equipment 114 and/or application 102 for a certain period of time. For example, the network may monitoring the type of traffic being sent by application 102 and/or user equipment 114 to determine whether a mode change from active mode to background mode should be initiated (NO at 210, and 212).

If the user continues to actively use application 102 and/or user equipment 114, the application 102 at user equipment 114 may, however, continue to use the active mode bearers as noted in 208 (Yes at 210, and 208).

In some exemplary embodiments, data may be sent in accordance with bearers at least one of configured or established for traffic communicated while the application 102, user equipment 114, or both are in background mode. For example, user equipment 114 may send, at 214, data generated by application 102 using the background mode bearers established at 205, when in the background mode (e.g., the user is not actively using the user equipment 114 and/or application 102). The background mode bearers established in 205 may include parameters defining the quality of service (QoS) allocated to the background mode bearers. These parameters may specify QoS class indicator (QCI), a minimum and/or a maximum bit rate for the uplink 126 and downlink 116, a guaranteed bit rate for the uplink 126 and downlink 116, and/or other quality of service parameters as well. Unlike the active mode bearers, the background mode bearers may be configured with less regard to QoS since the user experience may not be impacted. In any case, the application 102 may send background mode traffic (e.g., data) to server 132 via the network, such as eNB-type base station 110 and/or packet gateway 128 in accordance with the background mode bearers established at 205 and the allocated quality of service parameters for the established background mode bearers.

Although 214 refers to sending data, application 102 may also receive any background mode traffic sent from eNB-type base station 110, in accordance with the background mode bearers established at 205 and the allocated quality of service parameters for the established background mode bearers. In some exemplary embodiments in which the same bearer (e.g., a default bearer) is used for both active and background modes, the bearer may be established with different parameters to handle normal/active traffic and background traffic (see, e.g., lines 7-24 and 41-58 of Table 1 and lines 5 and 9-13 of Table 2).

In some exemplary embodiments, the background traffic refers to background traffic in accordance with 3GPP TR 36.822, LTE RAN Enhancements for Diverse Data Applications, V0.2.0 (2011-11), although the background traffic may take other forms as well. In the case of 3GPP TR 36.822, the background traffic may be characterized as traffic from the autonomous exchange of user plane data packets between the user equipment and the network without any specific user interaction at the user equipment.

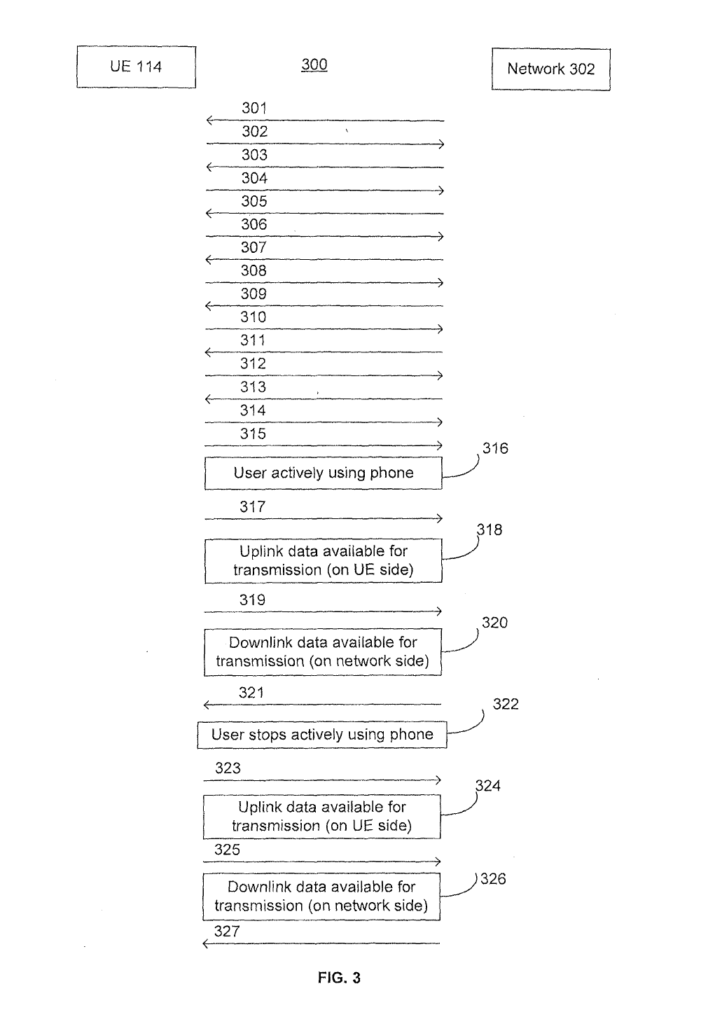

FIG. 3 depicts an example process 300 between user equipment 114 and a network 302, in accordance with some exemplary embodiments. The network 302 may include at least one of a base station 110 (e.g., an eNB-type base station and the like), a mobility management entity 150, and/or other nodes as well. The description of process 300 also refers to FIG. 1.

At 301, the eNB-base station 110 may send to user equipment 114 a radio resource control (RRC) message providing system information regarding the broadcast channel (BCCH) to allow the user equipment 114 to transmit and receive via uplink 126 and downlink 116.

At 302, the user equipment 114 may send to eNB-type base station 110 a message, such as a radio resource control connection request (RRCConnectionRequest) message. At 303, the eNB-type base station 110 may respond to the RRCConnectionRequest message by sending a radio resource control connection setup (RRCConnection Setup) message to user equipment 114.

At 304, the user equipment 114 may send a radio resource control connection setup complete (RRCConnectionSetupComplete) message to the eNB-type base station 110 to confirm the successful completion of the connection establishment and to initiate an attach procedure by including an attach request (ATTACH REQUEST) message, which is sent on to the mobility management entity 150. The user equipment 114 may also send a packet data network connectivity request (PDN CONNECTIVITY REQUEST) message to eNB-type base station 110 and the mobility management entity 150.

At 305, the network 302 responds to the user equipment 114. For example, the eNB-type base station 110 may respond with a downlink information transfer (DLInformationTransfer) message, and the mobility management entity 150 may respond with an authentication request message.

At 306, user equipment 114 may send an authentication response message to mobility management entity 150, and send an uplink information transfer (ULInformationTransfer) message to the eNB-type base station 110.

At 307, the eNB-type base station 110 may respond to 306 by sending a downlink information transfer (DLInformationTransfer) message, and the mobility management entity 150 may respond to 306 by sending a security mode message, such as SecurityModeCommand message.

At 308, the user equipment 114 may send to the mobility management entity 150 a security mode complete message, and the user equipment 114 may establish an initial security configuration.

At 309, the network 302, such as eNB-type base station 110, may send a message, such as a security mode command (SecurityModeCommand) message to activate access stratum (AS) security.

At 310, the user equipment 114 may send a message, such as security mode complete (SecurityModeComplete) message, and establish the initial security configuration.

At 311, the network, such as eNB-type base station 110, may transmit another message, such as a user equipment capability inquiry (UECapabilityEnquiry) message, to initiate at the user equipment 114 a radio access capability transfer procedure.

At 312, the user equipment 114 may transmit the user equipment capability information by sending for example a UECapabilityInformation message to transfer the radio access capability of user equipment 114.

At 313, the eNB-type base station 110 may send to user equipment 114 a radio resource control connection reconfiguration (RRCConnectionReconfiguration) message to establish a default bearer. This RRCConnectionReconfiguration message may include an attach acceptance (ATTACH ACCEPT) message, which may also include, or be associated with, a context request message (e.g., an ACTIVATE DEFAULT EPS BEARER CONTEXT REQUEST message). Moreover, in some exemplary embodiments, separate configurations and/or parameters may be included in ACTIVATE DEFAULT EPS BEARER CONTEXT REQUEST message for the active mode traffic and background traffic, although other types of messages may be used as well to convey to the user equipment the bearers for active traffic and the bearers for background traffic.

Table 2 described further below defines an example of context request message, such as an ACTIVATE DEFAULT EPS (enhanced packet system) BEARER CONTEXT REQUEST message, sent at 313 from the network 302 to user equipment 114. The ACTIVATE DEFAULT EPS BEARER CONTEXT REQUEST message may include the configuration and parameters for active mode bearers and background mode bearers. At 314, the user equipment 114 may send a radio resource control connection reconfiguration complete message (RRCConnectionReconfigurationComplete) to confirm the establishment of default bearer.

At 315, the user equipment 114 may send to the eNB-type base station 110 an uplink information transfer (ULInformationTransfer) message, and may send to the mobility management entity 150 an ATTACH COMPLETE message and an context request acceptance message, such as an ACTIVATE DEFAULT EPS BEARER CONTEXT ACCEPT message.

At 316, the user may be actively using application 102 and/or user equipment 114. For example, a screen (or display) on the user equipment may light while the user actively uses the application 102, or the application 102 may be sending a certain type of traffic, such as hyper text transfer protocol commands indicative of the user interacting with application 102. In both of these examples, it can be determined whether the application 102 and the user equipment 114 are in active mode.

At 317, the user equipment 114 may send to the eNB-type base station 110 and/or mobility management entity 150 a message indicating user equipment 114 is in an active mode. For example, the user equipment 114 may send an active mode indication message to the eNB-type base station 110 and/or mobility management entity 150. Although in some exemplary embodiments, message 317 may not be sent as the network 302 may determine whether the user equipment 114 is in active mode or background mode without the message 317 being sent. For example, the network 302 may monitor the traffic from the application 102 and user equipment 114 to determine whether the mode is active or background.

At 318, uplink data may be available for transmission from the user equipment 114 to the eNB-type base station 110 via uplink 126. As such, the user equipment 114 may send, at 319, the available data using the bearers allocated, at 313, to user equipment 114. Those bearers may be established for use in sending traffic when the application 102 is in active mode.

At 320, downlink data may be available for transmission from eNB-type base station 110 to user equipment 114 via downlink 116. As such, the eNB-type base station 110 may send, at 321, the available data using the bearers allocated, at 313, for active traffic/data.

At 322, the user may stop actively using application 102 and/or the user equipment 114. For example, a screen (or display) on the user equipment may go dark (or go into a screen saver mode) because the user stops using the application 102 for a certain period of time, or there may some other type of indication from upper layers that the application and/or user equipment is a background mode. Moreover, to determine whether application 102 and/or user equipment is not active, the keyboard of user equipment may be monitored to determine if there is inactivity for a certain period of time. Additionally, the application 102 may also indicate whether it is in background or active mode. Furthermore, an acceleration sensor in the user equipment may be monitored as well to determine whether the user equipment is actively being used. For example, an application or another portion of the user equipment (e.g., a radio communication portion, modem, and the like) may determine whether the application 102 and/or the user equipment 114 is in background mode or active mode based on data characteristics, such as when uplink and downlink data transmissions occur infrequently.

At 323, user equipment 114 may send a message to the eNB-type base station 110 and/or mobility management entity 150. The message may indicate that the user equipment 114 is in background mode. For example, user equipment 114 may send an active mode indication message indicating “background mode” to the eNB-type base station 110 and/or mobility management entity 150. Although in some exemplary embodiments, message 323 may not be sent as the network 302 may determine whether user equipment 114 is in background mode without the message 323 being sent.

At 324, uplink data may be available for transmission from user equipment 114 to eNB-type base station 110 via uplink 126. As such, the user equipment 114 may send, at 325, available data using the bearers allocated for background traffic at 313.

At 326, downlink data may be available for transmission from eNB-type base station 110 to the user equipment 114 via downlink 116. In addition, the eNB-type base station 110 may send, at 327, the available traffic/data using the bearers allocated for background traffic at 313.

In some implementations consistent with 3GPP TS 36.331, 3rd Generation Partnership Project; Technical Specification Group Radio Access Network; Evolved Universal Terrestrial Radio Access (E-UTRA); Radio Resource Control (RRC); Protocol specification (Release 10) and/or subsequent revisions thereto, a RadioResourceConfigDedicated message is used to setup, modify, and/or release radio bearers, as well as to modify the media access control (MAC) main configuration, to modify the semi-persistent scheduling (SPS) configuration, and to modify the dedicated physical configuration. The RadioResourceConfigDedicated information element (which may be carried within the RRCConnectionReconfiguration message) may be configured as shown at Table 1. For example, the RadioResourceConfigDedicated information element may be sent at 313 to allocate the access stratum (AS) bearers for active traffic generated by application 102 and the AS bearers for background traffic generated by application 102. In some exemplary embodiments, this information element is sent as part of one or more of the following messages: RRCConnectionSetup, RRCConnectionReconfiguration, and RRCConnectionReestablish.

Table 1 below depicts an example of an information element, such as Radio ResourceConfigDedicated information element. In some exemplary embodiments, the information element of Table 1 is associated with physicalConfigDedicated (see line 12 at Table 1 below) to establish the bearers for background mode traffic and active mode traffic.

TABLE 1

| Line | | | | |
|---|---|---|---|---|
| Number | Information Element | | | |
| 1 | -- ASN1START | | | |
| 2 | | | | |
| 3 | RadioResourceConfigDedicated ::= | SEQUENCE { | | |
| 4 | srb-ToAddModList | SRB-ToAddModList | OPTIONAL, | -- |
| | Cond HO-Conn | | | |
| 5 | drb-ToAddModList | DRB-TOAddModList | OPTIONAL, | -- |
| | Cond HO-toEUTRA | | | |
| 6 | drb-ToReleaseList | DRB-ToReleaseList | OPTIONAL, | -- |
| | Need ON | | | |
| 7 | mac-MainConfig | CHOICE { | | |
| 8 | explicitValue | MAC-MainConfig, | | |
| 9 | defaultValue | NULL | | |
| 10 | } OPTIONAL, -- | | | |
| | Cond HO-toEUTRA2 | | | |
| 11 | sps-Config | SPS-Config | OPTIONAL, | -- |
| | Need ON | | | |
| 12 | physicalConfigDedicated | PhysicalConfigDedicated | OPTIONAL, | -- |
| | Need ON | | | |
| 13 | ..., | | | |

| | | | |
|---|---|---|---|
| 14 | [[ rlf-TimersAndConstants-r9 | RLF-TimersAndConstants-r9 | OPTIONAL -- |
| | Need ON | | |
| 15 | ]], | | |
| 16 | [[ measSubframePatternPCell-r10 | MeasSubframePatternPCell-r10 | OPTIONAL -- |
| | Need ON | | |
| 17 | ]] | | |
| 18 | } | | |
| 19 | | | |

| 20 | RadioResourceConfigDedicatedSCell-r10 ::= SEQUENCE { | |
|---|---|---|
| 21 | -- UE specific configuration extensions applicable for an SCell | |
| 22 | physicalConfigDedicatedSCell-r10 | PhysicalConfigDedicatedSCell-r10 OPTIONAL, |
| 23 | ... | |
| 24 | } | |
| 25 | | |

| | | |
|---|---|---|
| 26 | SRB-ToAddModList ::= | SEQUENCE (SIZE (1..2)) OF SRB-ToAddMod |
| 27 | | |

| 28 | SRB-ToAddMod ::= SEQUENCE { | |
|---|---|---|
| 29 | srb-Identity | INTEGER (1..2), |
| 30 | rlc-Config | CHOICE { |
| 31 | explicitValue | RLC-Config, |
| 32 | defaultValue | NULL |

| | | |
|---|---|---|
| 33 | } OPTIONAL, | -- |
| | Cond Setup | |

| | | |
|---|---|---|
| 34 | logicalChannelConfig | CHOICE { |
| 35 | explicitValue | LogicalChannelConfig, |
| 36 | defaultValue | NULL |

| | | |
|---|---|---|
| 37 | } OPTIONAL, | -- |
| | Cond Setup | |
| 38 | ... | |
| 39 | } | |
| 40 | | |

| | | |
|---|---|---|
| 41 | DRB-ToAddModList ::= | SEQUENCE (SIZE (1..maxDRB)) OF DRB-ToAddMod |
| 42 | | |

| 43 | DRB-ToAddMod ::= SEQUENCE { | | | |
|---|---|---|---|---|
| 44 | eps-BearerIdentity | INTEGER (0..15) | OPTIONAL, | -- Cond |
| | DRB-Setup | | | |
| 45 | drb-Identity | DRB-Identity, | | |
| 46 | pdcp-Config | PDCP-Config | OPTIONAL, | -- Cond |
| | PDCP | | | |
| 47 | rlc-Config | RLC-Config | OPTIONAL, | -- Cond |
| | Setup | | | |
| 48 | logicalChannelIdentity | INTEGER (3..10) | OPTIONAL, | -- Cond |
| | DRB-Setup | | | |
| 49 | logicalChannelConfig | LogicalChannelConfig | OPTIONAL, | -- Cond |
| | Setup | | | |
| 50 | ... | | | |
| 51 | } | | | |
| 52 | | | | |

| | | |
|---|---|---|
| 53 | DRB-ToReleaseList ::= | SEQUENCE (SIZE (1..maxDRB)) OF DRB-Identity |
| 54 | | |

| | | |
|---|---|---|
| 55 | MeasSubframePatternPCell-r10 ::= | CHOICE { |
| 56 | release | NULL, |

| | | |
|---|---|---|
| 57 | setup | MeasSubframePattern-r10 |
| 58 | } | |
| 59 | | |
| 60 | -- ASN1STOP | |

Table 2 below depicts examples of information elements used in a message sent from the user equipment 114 to network 302 for activating a default bearer context request in implementations consistent with 3GPP TS 24.301 V11.1.0 (2011-12), Technical Specification: 3rd Generation Partnership Project; Technical Specification Group Core Network and Terminals; Non-Access-Stratum (NAS) protocol for Evolved Packet System (EPS); Stage 3 (Release 11) (hereinafter TS 24.301), and subsequent versions thereof. In some exemplary embodiments, one or more of the information elements at Table 2 may be included in the ACTIVATE DEFAULT EPS BEARER CONTEXT ACCEPT message described above with respect to 315, although other types of messages may be used as well.

TABLE 2

| Line | IEI | Information Element | Type/Reference | Presence | Format | Length |
|---|---|---|---|---|---|---|
| 1 | | Protocol discriminator | Protocol discriminator | M | V | ½ |
| | | | 9.2 | | | |
| 2 | | EPS bearer identity | EPS bearer identity | M | V | ½ |
| | | | 9.3.2 | | | |
| 3 | | Procedure transaction identity | Procedure transaction identity | M | V | 1 |
| | | | 9.4 | | | |
| 4 | | Activate default EPS bearer | Message type | M | V | 1 |
| | | context request message identity | 9.8 | | | |
| 5 | | EPS QoS | EPS quality of service | M | LV | 2-10 |
| | | | 9.9.4.3 | | | |
| 6 | | Access point name | Access point name | M | LV | 2-101 |
| | | | 9.9.4.1 | | | |
| 7 | | PDN address | PDN address | M | LV | 6-14 |
| | | | 9.9.4.9 | | | |
| 8 | 5D | Transaction identifier | Transaction identifier | O | TLV | 3-4 |
| | | | 9.9.4.17 | | | |
| 9 | 30 | Negotiated QoS | Quality of service | O | TLV | 14-18 |
| | | | 9.9.4.12 | | | |
| 10 | 32 | Negotiated LLC SAPI | LLC service access point identifier | O | TV | 2 |
| | | | 9.9.4.7 | | | |
| 11 | 8- | Radio priority | Radio priority | O | TV | 1 |
| | | | 9.9.4.13 | | | |
| 12 | 34 | Packet flow Identifier | Packet flow Identifier | O | TLV | 3 |
| | | | 9.9.4.8 | | | |
| 13 | 5E | APN-AMBR | APN aggregate maximum bit rate | O | TLV | 4-8 |
| | | | 9.9.4.2 | | | |
| 14 | 58 | ESM cause | ESM cause | O | TV | 2 |
| | | | 9.9.4.4 | | | |
| 15 | 27 | Protocol configuration options | Protocol configuration options | O | TLV | 3-253 |
| | | | 9.9.4.11 | | | |
| 16 | B- | Connectivity type | Connectivity type | O | TV | 1 |
| | | | 9.9.4.2A | | | |

In some exemplary embodiments, one or more of the following messages may be sent by the network 302 (or a node therein) to the user equipment 114 to initiate the bearers for the active mode traffic and the background mode traffic: ACTIVATE DEFAULT EPS BEARER CONTEXT REQUEST/ACCEPT message, ACTIVATE DEFAULT EPS BEARER CONTEXT REQUEST/REJECT message; ACTIVATE DEDICATED EPS BEARER CONTEXT REQUEST/ACCEPT message; ACTIVATE DEDICATED EPS BEARER CONTEXT REQUEST/REJECT message; MODIFY EPS BEARER CONTEXT REQUEST/ACCEPT message; MODIFY EPS BEARER CONTEXT REQUEST/REJECT message; and RRCConnectionReconfiguration for AS bearer.

In some exemplary embodiments, one or more of the following messages may be sent by the user equipment 114 to the network 302 to initiate the bearers for the active mode traffic and the background mode traffic: BEARER RESOURCE ALLOCATION REQUEST message; BEARER RESOURCE ALLOCATION REQUEST/REJECT message; BEARER RESOURCE MODIFICATION REQUEST message; and BEARER RESOURCE MODIFICATION REQUEST/REJECT message.

In some exemplary embodiments, for access stratum (AS) bearers the configurations/parameters of Table 3 may be used for active mode traffic and background mode traffic. Specifically, Table 3 shows the information included in the physicalConfigDedicated information noted above at line 12 of Table 1.

TABLE 3

| | | |
|---|---|---|
| DRB-ToAddMod ::= SEQUENCE { | | |
| eps-BearerIdentity | INTEGER (0..15) | OPTIONAL, -- Cond DRB-Setup |
| drb-Identity | DRB-Identity, | |
| pdcp-Config | PDCP-Config | OPTIONAL, -- Cond PDCP |
| rlc-Config | RLC-Config | OPTIONAL, -- Cond Setup |
| logicalChannelIdentity | INTEGER (3..10) | OPTIONAL, -- Cond DRB-Setup |
| logicalChannelConfig | LogicalChannelConfig | OPTIONAL, -- Cond Setup |
| ... | | |
| } | | |

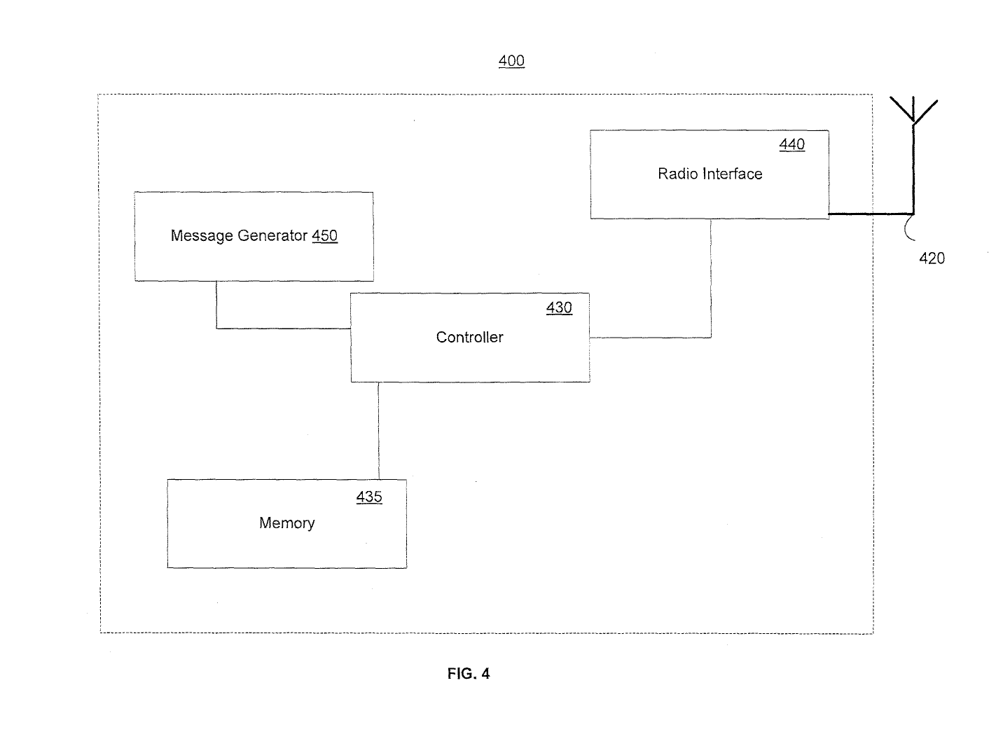

FIG. 4 depicts an example implementation of a base station 400, which may be implemented at base station 110. The base station includes antenna(s) 420 configured to transmit via a downlink and configured to receive uplinks via the antenna(s) 420. The base station further includes a radio interface 440 coupled to the antenna 420, a processor 430 for controlling the base station 400 and for accessing and executing program code stored in memory 435. The radio interface 440 further includes other components, such as filters, converters (e.g., digital-to-analog converters and the like), mappers, a Fast Fourier Transform (FFT) module, and the like, to generate symbols for a transmission via one or more downlinks and to receive symbols (e.g., via an uplink). In some implementations, the base station is also compatible with GERAN, UTRAN, and E-UTRAN, and/or other standards and specifications as well. Moreover, the RF signals of downlinks and uplinks are configured in accordance with one or more of these standards and/or specifications. The base station may include a message generator 450, which may generate one or more of the messages described herein.

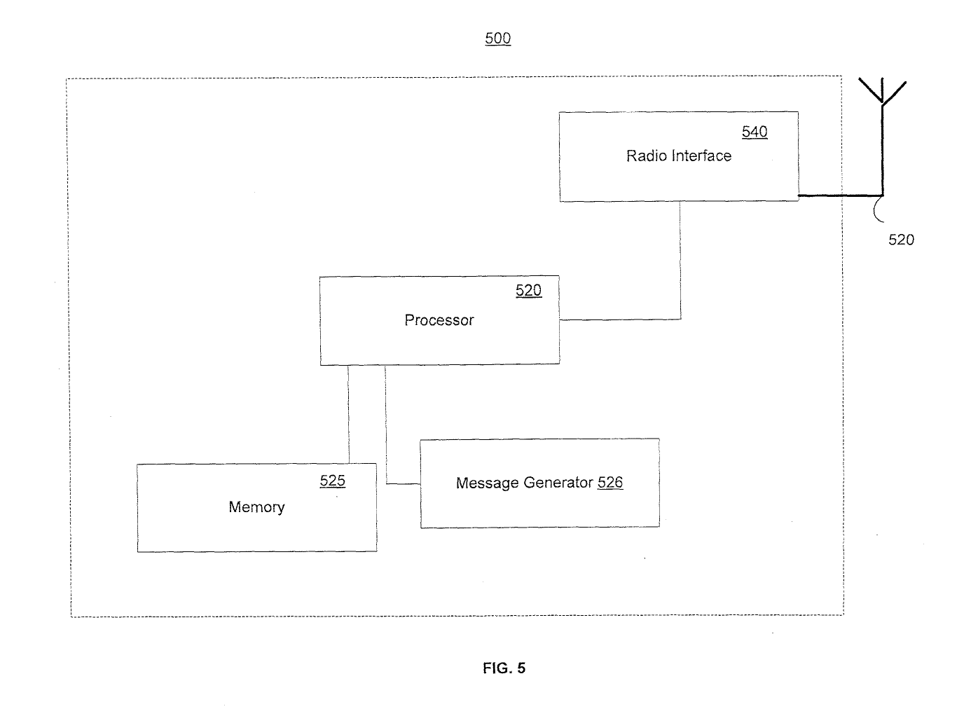

FIG. 5 depicts a block diagram of user equipment 500, which may be used as user equipment 114. The user equipment 500 includes an antenna 520 for receiving a downlink and transmitting via an uplink. The user equipment 500 also includes a radio interface 540, which may include other components, such as filters, converters (e.g., digital-to-analog converters and the like), symbol demappers, an Inverse Fast Fourier Transform (IFFT) module, and the like, to process symbols, such as OFDMA symbols, carried by a downlink or an uplink. In some implementations, the user equipment 500 may also be compatible with GERAN, UTRAN, E-UTRAN, and/or other standards and specifications as well. The user equipment 500 may further include at least one processor, such as processor 520, for controlling user equipment 500 and for accessing and executing program code stored in memory 525. The user equipment 500 may also include application 102 and a message generator 526 for generating one or more of the messages described herein.

The subject matter described herein may be embodied in systems, apparatus, methods, and/or articles depending on the desired configuration. For example, the base stations and user equipments (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1-43. (canceled)

44. A method comprising:
processing parameters defining at least a first bearer and a second bearer, the first bearer and the second bearer established for a service at a processor;
sending, based on at least the first bearer, traffic generated by the service, when at least one of the service and the processor is not in a background mode; and
sending, based on at least the second bearer, background traffic generated by the service, when at least one of the service and the processor is in the background mode.

45. The method of claim 44, wherein the first bearer comprises at least an access stratum bearer and a non-access stratum bearer including access stratum configuration information for the traffic and non-access stratum configuration information for the traffic, and wherein the second bearer comprises at least an access stratum bearer and a non-access stratum bearer including access stratum configuration information for the background traffic and non-access stratum configuration information for the background traffic, wherein the second bearer is configured for the background traffic.

46. The method of claim 44, wherein the first bearer and second bearer are the same bearer, wherein the second bearer includes different configuration information, when compared to the first bearer.

47. The method of claim 44, wherein the traffic comprises data sent by the service, when a user accesses and interacts with at least one of the service and the processor.

48. The method of claim 44, wherein the background traffic comprises data sent by the service, when a user of the service does not at least one of access and interact with the service.

49. The method of claim 44, wherein the background traffic comprises at least one of a status message, a keep-alive message, and an update message sent to another application responsive to the application.

50. An apparatus, comprising:
at least one processor; and
at least one memory including computer program code, the at least one memory including the computer program code configured to, with the at least one processor, cause the apparatus to at least:
process parameters defining at least a first bearer and a second bearer, the first bearer and the second bearer established for a service at a processor;
send, based on at least the first bearer, traffic generated by the service, when at least one of the service and the processor is not in a background mode; and
send, based on at least the second bearer, background traffic generated by the service, when at least one of the service and the processor is in the background mode.

51. The apparatus of claim 50, wherein the first bearer comprises at least an access stratum bearer and a non-access stratum bearer including access stratum configuration information for the traffic and non-access stratum configuration information for the traffic.

52. The apparatus of claim 50, wherein the second bearer comprises at least an access stratum bearer and a non-access stratum bearer including access stratum configuration information for the background traffic and non-access stratum configuration information for the background traffic, wherein the second bearer is configured for the background traffic.

53. The apparatus of claim 50, wherein the first bearer and second bearer are the same bearer, wherein the second bearer includes different configuration information, when compared to the first bearer.

54. The apparatus of claim 50, wherein the different configuration information includes quality of service parameters.

55. The apparatus of claim 50, wherein the traffic comprises data sent by the service, when a user accesses and interacts with at least one of the service and the processor.

56. The apparatus of claim 50, is further configured to enter, when at least one of the service and the processor is inactive for the first period of time, the background mode.

57. The apparatus of claim 50, wherein the background traffic comprises at least one of a status message, a keep-alive message, and an update message sent to another application responsive to the application.

58. An apparatus, comprising:
at least one processor; and
at least one memory including computer program code, the at least one memory including the computer program code configured to, with the at least one processor, cause the apparatus to at least:
establish at least a first bearer and a second bearer;
send, based on at least the first bearer, traffic to a user equipment, when at least one of a service and the user equipment is not in a background mode; and
send, based on at least the second bearer, background traffic to the user equipment, when at least one of the service and the user equipment is in the background mode.

59. The apparatus of claim 58, wherein the first bearer comprises at least an access stratum bearer and a non-access stratum bearer including access stratum configuration information for the traffic and non-access stratum configuration information for the traffic, and wherein the second bearer comprises at least an access stratum bearer and a non-access stratum bearer including access stratum configuration information for the background traffic and non-access stratum configuration information for the background traffic, wherein the second bearer is configured for the background traffic.

60. The apparatus of claims 58, wherein the first bearer and second bearer are the same bearer, wherein the second bearer includes different configuration information, when compared to the first bearer.

61. The apparatus of claim 58, wherein the different configuration information includes quality of service parameters.

62. The apparatus of claim 58, is further configured to receive from the user equipment an indication of whether the user equipment is in the background mode.

63. The apparatus of claim 58, is further configured to determine from the traffic received from the user equipment whether the user equipment is in the background mode.
